(19) United States
(12) Patent Application Publication
(10) Pub. No.: US 2014/0380172 A1
(43) Pub. Date: Dec. 25, 2014

(54) TERMINAL APPARATUS AND CONTROLLING METHOD THEREOF

(71) Applicant: SAMSUNG ELECTRONICS CO., LTD., Suwon-si (KR)

(72) Inventor: Mun-seok KIM, Hwaseong (KR)

(73) Assignee: SAMSUNG ELECTRONICS CO., LTD., Suwon-si (KR)

(21) Appl. No.: 14/294,676

(22) Filed: Jun. 3, 2014

(30) Foreign Application Priority Data
Jun. 24, 2013 (KR) 10-2013-0072512

(51) Int. Cl. H04M 1/725; G06F 3/0484

(52) U.S. Cl. CPC H04M 1/72547; G06F 3/04842
USPC 715/733

(57) ABSTRACT

A terminal apparatus and a controlling method thereof are provided. The controlling method, according to an exemplary embodiment, includes displaying a plurality of messages which are transmitted/received to/from another terminal apparatus, when one of a plurality of the displayed message is selected, displaying an input window to generate a response message of the selected message, when a transmission command is input after a response message is input on the input window, transmitting identification information of the selected message and the response message to the another terminal apparatus, and displaying the response message around the selected message. Accordingly, the terminal apparatus may clarify correlation between messages which are transmitted/received by controlling each of a plurality of messages which are transmitted/received to/from other terminal apparatuses independently, thereby helping produce clear communication between users through those transmitted/received messages.

### CROSS-REFERENCE TO RELATED APPLICATIONS

This application claims priority from Korean Patent Application No. 10-2013-0072512, filed in the Korean Intellectual Property Office on Jun. 24, 2013, the disclosure of which is incorporated herein by reference.

### BACKGROUND OF THE INVENTION

1. Field of the Invention

Aspects of the exemplary embodiments relate to a terminal apparatus and a controlling method thereof, and more particularly, to a terminal apparatus to control messages which have been transmitted/received independently and a controlling method thereof.

2. Description of the Related Art

In general, a first terminal apparatus such as a smart phone may transmit and/or receive messages to/from another or second terminal apparatus through a messenger application. For example, when the first message is received from the another or second terminal apparatus, a display apparatus displays the received first message on the screen. Subsequently, upon a user request, the display apparatus may transmit a second message regarding the received first message to the another or second terminal apparatus. In this case, the display apparatus may display the first message received from the another or second terminal apparatus on top of the screen, and display the second message which is transmitted to the another or second terminal apparatus under the first message.

Meanwhile, when a third message is received from another or third terminal apparatus before the second message is transmitted, the display apparatus displays the first and the third messages received from the another or third terminal apparatus and then, displays the second message which is transmitted to the another or second terminal apparatus under the third message. The another or second terminal apparatus also displays the first and the third messages which are transmitted to the display apparatus on the screen and then, displays the second which is received from the second display apparatus under the third message.

As such, the prior art display apparatus displays messages not based on correlation between messages which are transmitted/received to/from another terminal apparatus but based on an absolute time sequence.

Accordingly, if the third message is received from the another or third terminal apparatus while a user is writing a response to the first message received from another terminal apparatus, he or she may have difficulties in deciding whether to complete the response message regarding the first message or write a response message regarding the third message. In addition, if the second message is received after the first and the third messages are transmitted, a user of another terminal apparatus may not be sure whether the received second message is a response message regarding the first message which is transmitted to the display apparatus or a response message regarding the third message, which may cause miscommunication between users.

### SUMMARY

Additional aspects and/or advantages will be set forth in part in the description which follows and, in part, will be apparent from the description, or may be learned by practice of the invention.

Exemplary embodiments may include a terminal apparatus which controls each of a plurality of messages which are transmitted/received between terminal apparatuses independently so as to clarify correlation between the messages transmitted/received.

A method for controlling a terminal apparatus according to an exemplary embodiment may include displaying a plurality of messages which are transmitted/received to/from another terminal apparatus, when one of a plurality of the displayed messages is selected, displaying an input window to generate a response message of the selected message, when a transmission command is input after a response message is input on the input window, transmitting identification information of the selected message and the response message to the another terminal apparatus, and displaying the response message around the selected message.

The input window to generate the response message may be displayed around the selected message.

The transmitting may include transmitting identification information of the response message as well to the another terminal apparatus.

The displaying the response message may include displaying the response message in a color which is different from colors of a plurality of the displayed messages.

The method may further include, when identification information regarding one of a plurality of messages which are transmitted to the another terminal apparatus and a response message are received from the another terminal apparatus, displaying the received response message around a transmission message corresponding to the identification information.

The method may further include, when a transmission message which is transmitted to the another terminal apparatus is selected from among a plurality of the displayed messages, displaying a menu window to control the selected transmission message, and when a user command to control the selected transmission message is input through the menu window, transmitting identification information regarding the selected transmission message and control information corresponding to the user command to the another terminal apparatus.

The menu window may include at least one of a typographical error notification menu, a mis-transmission notification menu, an emoticon input menu, a re-input menu, and a re-transmission menu.

The method may further include changing and displaying the selected transmission message according to the control information.

When messages are transmitted/received to/from a plurality of other terminal apparatuses, the input window may include a selection menu to select another terminal apparatus to which the response message is transmitted, and the transmitting may include transmitting identification information of the selected message and the response message to at least one another terminal apparatus which is selected through the selection menu.

A terminal apparatus according to an exemplary embodiment may include a communicator configured to perform communication with another terminal apparatus, a display configured to display messages which are transmitted/received to/from the another terminal apparatus through the communicator, an input unit configured to receive a user command, and a controller configured to the communicator and the display to, when one of a plurality of the displayed messages is selected according to a user command input through the input unit, display an input window to generate a response message of the selected message, and when a transmission command is input after a response message is input on the input window through the input unit, transmit identification information of the selected message and the response message to the another terminal apparatus and display the response message around the selected message.

The display may display an input window to generate the response message around the selected message.

The controller may control the communicator to transmit identification information of the response message as well to the another terminal apparatus.

The controller may control the display to display the response message in a color which is different from colors of a plurality of the display messages.

The controller may control the display to, when identification information regarding one of a plurality of messages which are transmitted to the another terminal apparatus and a response message are received from the another terminal apparatus through the communicator, display the received response message around a transmission message corresponding to the identification information.

The controller may control the display to, when a transmission message transmitted to the another terminal apparatus is selected from among a plurality of the displayed messages, display a menu window to control the selected transmission message, and the controller may control the communicator to, when a user command to control the selected transmission message is input through the menu window, transmit identification information regarding the selected transmission message and control information corresponding to the user command to the another terminal apparatus.

The menu window may include at least one of a typographical error notification menu, a mis-transmission notification menu, an emoticon input menu, a re-input menu, and a re-transmission menu.

The controller may control the display to change and display the selected transmission message according to the control information.

When messages are transmitted/received to/from a plurality of other terminal apparatuses, the input window may include a selection menu to another terminal apparatus to which the response message is transmitted, and the controller may control the communicator to transmit identification information of the selected message and the response message to at least one another terminal apparatus which is selected through the selection menu.

According to various exemplary embodiments, the terminal apparatus may clarify correlation between messages which are transmitted/received by controlling each of a plurality of messages which are transmitted/received to/from other terminal apparatuses independently, thereby helping clear communication between users through those transmitted/received messages.

### BRIEF DESCRIPTION OF THE DRAWINGS

The above features and/or other aspects and advantages will become more apparent and more readily appreciated from the following description of the embodiments taken in conjunction with the accompanying drawings, in which:

FIG. 1 is a block diagram illustrating a terminal apparatus according to an exemplary embodiment;

FIG. 2 is an exemplary view displaying messages that a terminal apparatus transmitted/received to/from another terminal apparatus according to an exemplary embodiment;

FIG. 3 is an exemplary view illustrating the feature of controlling messages that a terminal apparatus transmitted/received to/from another terminal apparatus according to an exemplary embodiment;

FIG. 4 is an exemplary view illustrating the feature of controlling messages that a terminal apparatus transmitted/received to/from a plurality of other terminal apparatuses according to an exemplary embodiment;

FIG. 5 is an exemplary view illustrating the feature that a terminal apparatus controls a message transmitted to another terminal apparatus based on message information received from another terminal apparatus according to an exemplary embodiment;

FIG. 6 is an exemplary view illustrating the feature that a terminal apparatus controls a message transmitted to another terminal apparatus according to a selection command on a displayed menu window according to an exemplary embodiment;

FIG. 7 is a flowchart illustrating a method for controlling a message that a terminal apparatus receives from another terminal apparatus according to an exemplary embodiment;

FIG. 8 is a flowchart illustrating a method that a terminal apparatus controls a message transmitted to another terminal apparatus based on message information received from another terminal apparatus according to an exemplary embodiment; and

FIG. 9 is a flowchart illustrating a method that a terminal apparatus controls a message transmitted to another terminal apparatus according to an exemplary embodiment.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

It should be observed the method steps and system components have been represented by conventional symbols in the figures, showing only specific details which are relevant for an understanding of the present disclosure. Further, details that may be readily apparent to person ordinarily skilled in the art may not have been disclosed. In the present disclosure, relational terms such as first and second, and the like, may be used to distinguish one entity from another entity, without necessarily implying any actual relationship or order between such entities.

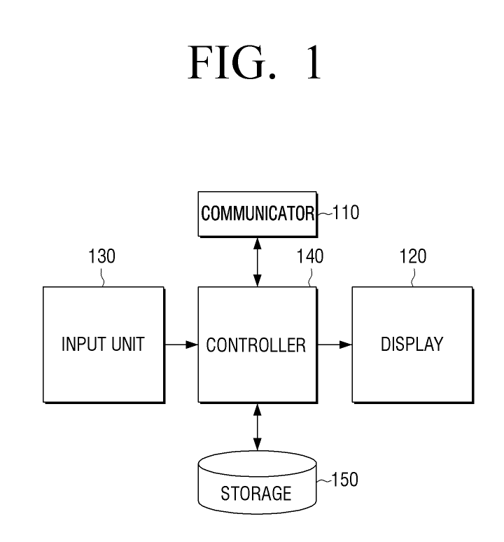

FIG. 1 is a block diagram illustrating a terminal apparatus according to an exemplary embodiment.

As illustrated in FIG. 1, a terminal apparatus, such as a smart phone and a smart television, comprises a communicator 110, a display 120, an input unit 130, a controller 140, and a storage 150.

The communicator 110 performs communication with at least one other terminal apparatus which is capable of performing wireless communication, such as a smart phone and a content server. Depending on an exemplary embodiment, the communicator 110 may be realized as a communication module, such as a near-field wireless communication module (not shown) and a wireless communication module (not shown). Herein, the near-field wireless communication module (not shown) is a communication module which performs wireless communication with another terminal apparatus in the vicinity and may be, for example, Bluetooth, Zigbee, Near Field Communication (NFC), and so on. The wireless communication module (not shown) is a communication module which performs communication with a first to a third terminal apparatuses 200 according to a wireless communication protocol such as WiFi, IEEE, etc. In addition, the wireless communication module may further include a wireless communication module which performs communication with a content server by connecting to a wireless communication network according to various mobile communication standards, such as 3rd Generation (3G), 3rd Generation Partnership Project (3GPP), Long Term Evolution (LTE), and so on.

The display 120 displays messages which are transmitted/received to/from another terminal apparatus through the communicator 110. The display 120 may be realized as a Liquid Crystal Display (LCD), an Organic Light Emitting Display (OLED), or a Plasma Display Panel (PDP), and may provide various display screens which can be provided through a terminal apparatus. In addition, the display 1220 may be realized as a touch screen which forms an inter-layer structure with a touch pad, and the touch screen may be configured to detect not only the location and size of a touch input but also the pressure of the touch input.

The input unit 130 receives various user commands. Depending on exemplary embodiments, the input unit 130 may receive a selection command with respect to each of received/transmitted messages which are displayed through the display 120, or may receive a message to be transmitted to another terminal apparatus. As such, the input unit 130, which receives various user commands, may be realized as an input panel. The input panel may be realized as a key pad with various function keys, number keys, special keys, text keys, etc. or in the form of touch screen.

The controller 140 controls overall operations of each element which constitutes a terminal apparatus. In particular, when one of a plurality of messages which are displayed through the display 120 is selected according to a user command input through the input unit 130, the controller 140 controls the display 120 to display an input window to generate a response message to the selected message. In accordance with the control command, the display 120 may display an input window to generate such a response message around the selected message according to the user command. Having the input window positioned around the selected message means that the input window is in visual association with or visually correlated to the selected message to visually show they are related.

When a transmission command is input after the response message is input on the input window through the input unit 130 while the input window is displayed, the controller 140 controls the communicator 110 to transmit identification information of the selected message and the response message to another terminal apparatus according to the user command. In this case, the controller 140 may control the communicator 110 to transmit the identification information of the corresponding response message along with the identification information of the selected message and the response message. Specifically, when the response message is input into the input window through the input unit 130, the controller 140 generates identification information regarding the corresponding response message and stores the information in the storage 150. Subsequently, the transmission command is input through the input unit 130, the controller 140 obtains identification information of the selected message from the storage 150 according to the user command. Then, the controller 140 transmits message information including the identification information regarding the corresponding response message along with the identification information of the selected message and the response message input into the input window.

Herein, the storage 150 matches and stores identification information regarding a plurality of messages which are displayed through the display 120 with coordinate information of each message. In addition, the storage 150 may store various data necessary to drive and control a terminal apparatus, Operation System (OS), and applications which are downloaded from a content server.

Meanwhile, the controller 140 controls the display 120 to display the response message which is input through the input window around the selected message according to the user command. In this case, the controller 140 may control the display 120 to display the response message which is displayed around the selected message in a different color from that of a plurality of messages which are displayed through the display 120. Accordingly, the display 120 may process and display the color of the response message distinctively from those of the plurality of messages. Again to display the response message around the selected message means that the two messages are displayed in visual association with each other or visually correlated to show they are related. The two messages may be shown in a way that they are visually not correlated in time of transmission or reception.

Meanwhile, when a terminal apparatus transmits/receives a message to/from a plurality of other terminal apparatuses, an input window to generate a response message regarding a selected message according to a user command includes a selection menu to select another terminal apparatus to which the corresponding response message is transmitted. When such a selection menu is selected, the controller 140 may control the communicator 110 to transmit identification information of the selected message and the response message to at least one of other terminal apparatuses according to the user command through the selection menu.

Meanwhile, when identification information regarding one of a plurality of messages which are transmitted to another terminal apparatus and a response message are received through the communicator 110, the controller 140 controls the display 120 to display the received response message around a transmission message corresponding to the received identification information. In this case, another terminal apparatus may also transmit identification information regarding the response message. Accordingly, when the response message is displayed around the transmission message corresponding to the identification information received from another terminal apparatus, the controller 140 may store the received identification information regarding the response message in the storage 150.

Meanwhile, when the transmission message which is transmitted to still another terminal apparatus is selected from among a plurality of displayed messages, the controller 140 controls the display 120 to display a menu window to control the selected transmission message. Accordingly, the display 120 may display a menu window to control the transmission message around the corresponding transmission message. Herein, the menu may include a typographical error notification menu, mis-transmission notification menu, an emoticon input menu, a re-input menu, and re-send menu.

When a user command to control the selected transmission message is input through the corresponding menu window while the menu window is displayed, the controller 140 controls the communicator 110 to transmit identification information regarding the selected transmission message and control information corresponding to the input user command to another terminal apparatus. Also, the controller 140 controls the display 120 to change and display the selected transmission message according to control information corresponding to the user command to control the selected transmission message.

So far, each configuration of a terminal apparatus according to an exemplary embodiment has been described in detail. Hereinafter, the operations of a terminal apparatus according to various exemplary embodiments will be described in greater detail.

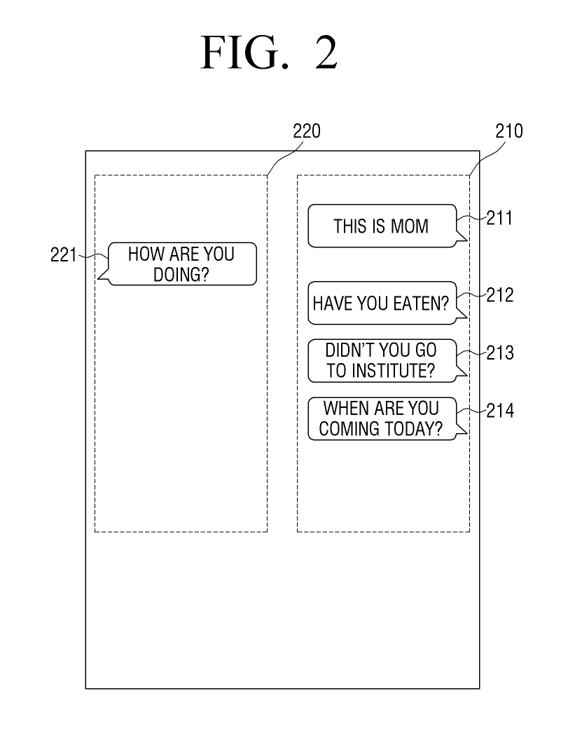

FIG. 2 is an exemplary view displaying messages that a terminal apparatus transmitted/received to/from another terminal apparatus according to an exemplary embodiment.

As illustrated in FIG. 2, a terminal apparatus may display messages that are transmitted/received to/from another terminal apparatus on the screen. Specifically, a terminal apparatus may display messages that are transmitted/received to/from another terminal apparatus in the form of box. More specifically, a terminal apparatus may display the first to the fourth message boxes 211˜214 regarding each of the messages received from another terminal apparatus in the first area 210, and display the fifth message box 221 regarding a message transmitted to the another terminal apparatus in the second area 220. In addition, the terminal apparatus may set and store identification information regarding each of the first to the fifth message boxes 211˜214, 221 displayed on the first and the second areas 210, 220. For example, identification information “#1˜#5” may be set for the first to the fifth message boxes 211˜214, 221.

As such, a user may select one of the first to the fifth message boxes 211˜214, 221 while the first to the fifth message boxes 211˜214, 221 for which identification is set are displayed. According to such a selection command, the terminal apparatus may control a message displayed on the selected message box. Hereinafter, the operation of the terminal apparatus of controlling a message displayed on a message box which is selected from among a plurality of displayed message boxes according to a user command in detail.

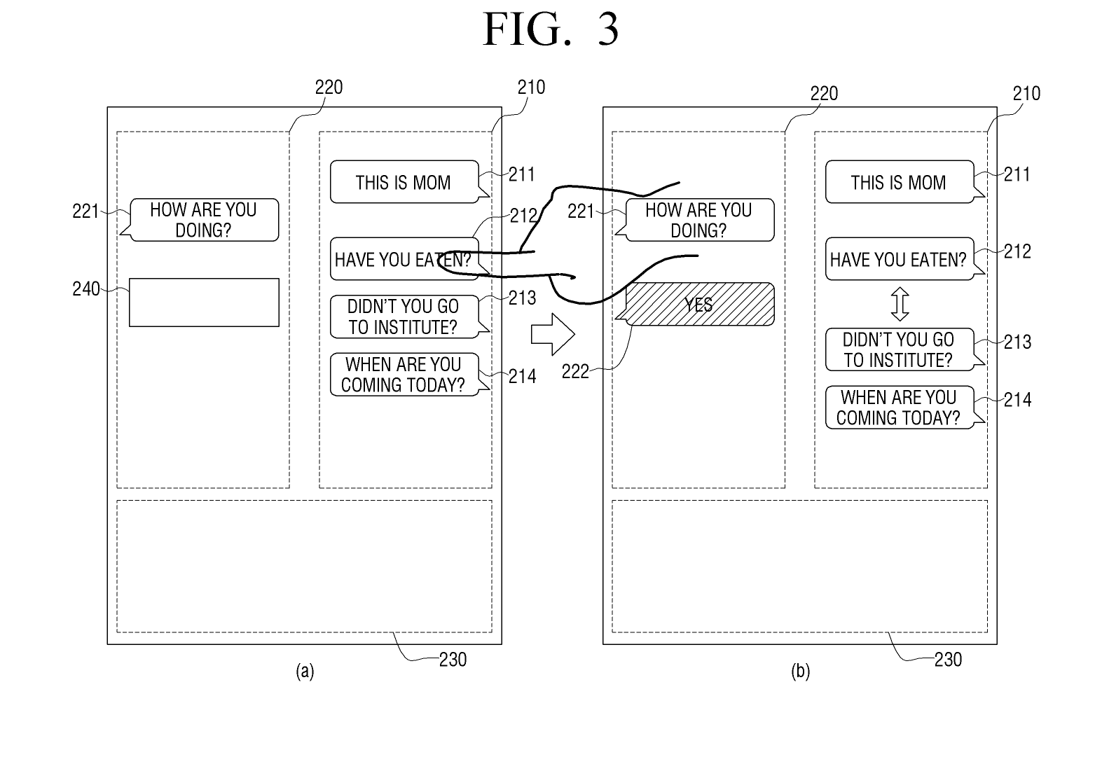

FIG. 3 is an exemplary view illustrating the feature of controlling messages that a terminal apparatus transmitted/received to/from another terminal apparatus according to an exemplary embodiment.

As illustrated in FIG. 3(a), a user may select the second message box 212 (indicated by the finger touch symbol) in order to transmit a response message regarding a message displayed on the second message box 212 from among message boxes displayed through the first area 210 to another terminal apparatus. When a selection command regarding the second box 212 is input, the terminal apparatus displays an input window 240 to generate a response message regarding the message displayed on the second box 212 around or in visual correlation with the second message box 212.

Depending on an exemplary embodiment to provide the visual correlation, the terminal apparatus may display the input window 240 to generate a response message in the second area 220 corresponding to an area which is vertically positioned between the second message box 212 and the third message box 213. However, the present invention is not limited thereto, and the terminal apparatus may display the input window 240 to generate a response message on the third area 230 where the input unit 130 such as a touch pad is displayed in the UI form.

As such, when a response message is input through the input unit 130 displayed in the third area 230 while the input unit 240 is displayed, the terminal apparatus displays the input response message on the input window 240 (see FIG. 3(6). For example, when the response message of “yes” is input through the input unit 130, the display 120 may display the response message of “yes” on the input window 240. When a transmission command is input after such a response message is input, the terminal apparatus converts the input window 240 where the response message of “yes” is displayed into a new message box 222 (hereinafter, referred to as the sixth message box) and displays the same. That is, the terminal apparatus may display the sixth message box 222 where the response message of “yes” is displayed on the screen as illustrated in FIG. 3 (b).

Meanwhile, the terminal apparatus sets and stores identification information regarding the sixth message box 222 while displaying the sixth message box 222 where the response message of “yes” is displayed on the screen. In this case, the terminal apparatus may set identification information regarding the sixth message box 222 to be different from identification information regarding the first to the fifth message boxes 211˜214, 221. As described in the above exemplary embodiment, if the identification information of each of the first to the fifth message boxes 211˜214, 221 is set to be “#1˜#5”, the terminal apparatus may set the identification information of the sixth message box 222 as “#6”.

Meanwhile, in order to help visually correlate and indicate visually that the response message displayed on the sixth message box 222 is a response message regarding the message displayed on the second message box 212, that is, box 222 is around 212, the terminal apparatus may display the second message box 212 and the third message box 213 to have an interval of a predetermined threshold value in between (see double headed arrow). In addition, the terminal apparatus may display the color of the sixth message box 222 to be different from the colors of the first to the fifth message boxes 211˜214, 221 as indicated by the hatching.

Meanwhile, when a transmission command is input after the response message is input through the input window 240, the terminal apparatus transmits the response message displayed on the sixth message box 222 and identification information of the second message box 212 which is selected according to a user request to another terminal apparatus. Accordingly, another terminal apparatus may display the response message received from the terminal apparatus around the transmission message corresponding to the identification information of the second message box 212 which is received from the terminal apparatus from among transmission messages which are transmitted to another terminal apparatus.

In a case where messages are transmitted/received to/from a plurality of other terminal apparatuses, the terminal apparatus may transmit a response message regarding a message displayed on the message box which is selected according to a user command from among a plurality of displayed message boxes to at least one of other terminal apparatuses. Hereinafter, the operation that a terminal apparatus which transmits/receives messages to/from a plurality of other terminal apparatuses transmits a response message regarding a message displayed on the message box which is selected according to a user command to at least one of other terminal apparatuses will be explained.

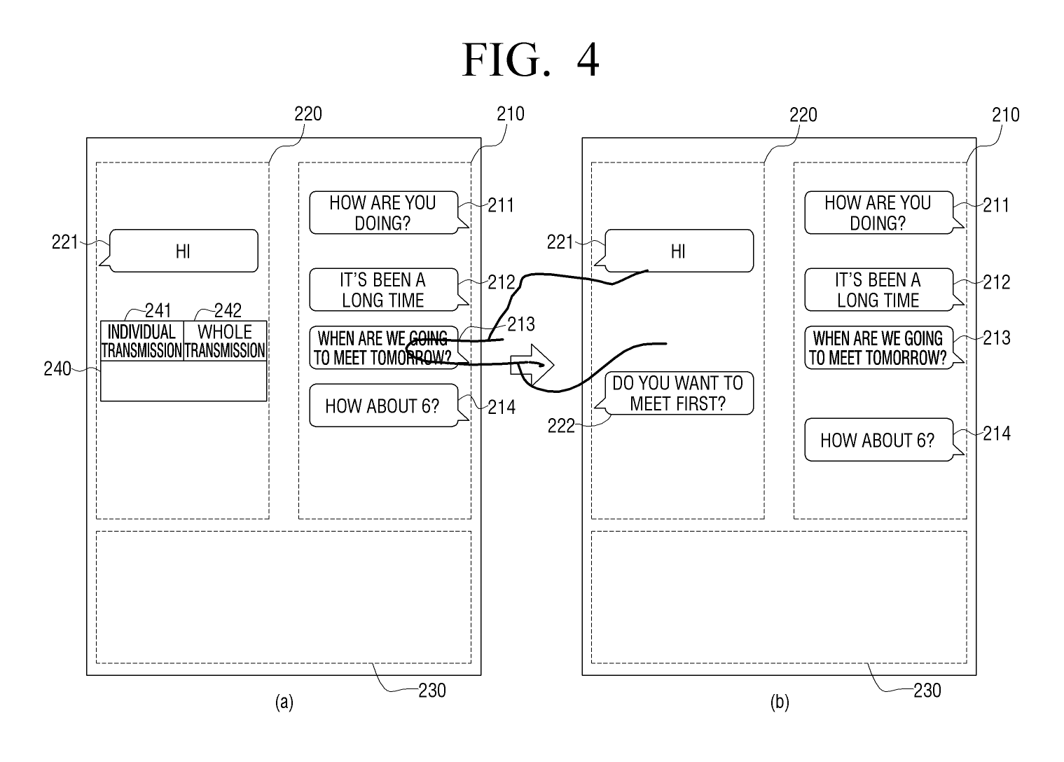

FIG. 4 is an exemplary view illustrating the feature of controlling messages that a terminal apparatus transmitted/received to/from a plurality of other terminal apparatuses according to an exemplary embodiment.

As illustrated in FIG. 4(a), a terminal apparatus may display a message box regarding a message received from a plurality of other terminal apparatuses in the first area 210, and a message box regarding a message transmitted to at least one of a plurality of other terminal apparatuses in the second area 220. Specifically, the first to the fourth message boxes 211˜214 regarding each message received from the first and the second other terminal apparatuses may be displayed in the first area 210, and the fifth message box 221 regarding a message transmitted to at least one of a plurality of other terminal apparatuses may be displayed in the second area 220. Meanwhile, the first and the third message boxes 211, 213 out of the first to the fourth message boxes 211˜214 which are displayed in the first area 210 may display a message received from the first another terminal apparatus, and the second and the fourth message boxes 212, 214 may display a message received from the second another terminal apparatus.

Meanwhile, a selection command regarding one of the first to the fifth message boxes 211˜214, 221 which are displayed in the first and the second areas 210, 220 may be input to the terminal apparatus. In this case, as described above, the terminal apparatus displays the input window 240 to generate a response message around the box which is selected according to a user command. For example, when a selection command regarding the third message box 213 from among the displayed message boxes is input through the first area 210, the terminal apparatus may display the input window 240 in the second area 220 corresponding to an area between the third message box 213 and the fourth message box 214 to again help provide a visual correlation. Note even thought the message of message box 214 was received displayed before the message of box 222, box 214 is displayed below box 222.

In this case, the terminal apparatus determines whether the message displayed on each of the first to the fourth message boxes 211˜214 which are displayed in the first area 210 is a message received from a plurality of other terminal apparatuses. Depending on an exemplary embodiment, the terminal apparatus may determine whether each message is received from another terminal apparatus or a plurality of other terminal apparatuses with reference to address information regarding the message displayed on each of the first to the fourth message boxes 211˜214. If it is determined that the message displayed on each of the first to the fourth message boxes 211˜214 which are displayed in the first area 210 is received from the first and the second other terminal apparatuses, the terminal apparatus displays the input window 240 including a selection menu to select another terminal apparatus to which a response message is transmitted in the second area 220. Herein, the selection menu may include an individual transmission 241 (transmit to the individual) and a whole transmission 242 (transmit to all the individuals). Accordingly, the terminal apparatus may display the input window 240 which includes the selection menu regarding the individual transmission 241 and the whole transmission 242.

When a transmission command is input after the response message which is input through the input unit 130 displayed in the third area 230 is displayed on the input window 240 while the input window 240 is displayed, the terminal apparatus converts the input window 240 where the response message is displayed into the sixth message box 222 for which identification information is set and displays the same as illustrated in FIG. 4(b). Subsequently, the terminal apparatus transmits the response message displayed on the sixth message box 222, identification information set on the sixth message box 222, and identification information of the second message box 212 which is selected according to a user request to another terminal apparatus.

In this case, the terminal apparatus may determine another terminal apparatus to which the response message displayed on the sixth message box 222, identification information set on the sixth message box 222, and identification information of the second message box 212 which is selected according to a user request are transmitted according to a selection menu input from a user from among selection menus regarding the individual transmission 241 and the whole selection 242 included in the input window 240.

Depending on an exemplary embodiment, when a selection menu regarding the individual transmission 241 is selected, the terminal apparatus may transmit the response message displayed on the sixth message box 222, identification information set on the sixth message box 222, and identification information of the second message box 212 which is selected according to a user request to the second another terminal apparatus which has transmitted a message displayed on the second message box 212.

Meanwhile, when a selection menu regarding the whole transmission 242 is selected, the terminal apparatus may transmit the response message displayed on the sixth message box 222, identification information set on the sixth message box 222, and identification information of the second message box 212 which is selected according to a user request to the first and the second terminal apparatuses.

As such, when messages are transmitted/received to/from a plurality of terminal apparatuses, the terminal apparatus according to an exemplary embodiment may transmit a response message regarding a received message to at least one of a plurality of other terminal apparatuses.

Hereinafter, the operation of controlling a transmission message that the terminal apparatus according to an exemplary embodiment transmits to another terminal apparatus based on message information received from another terminal apparatus.

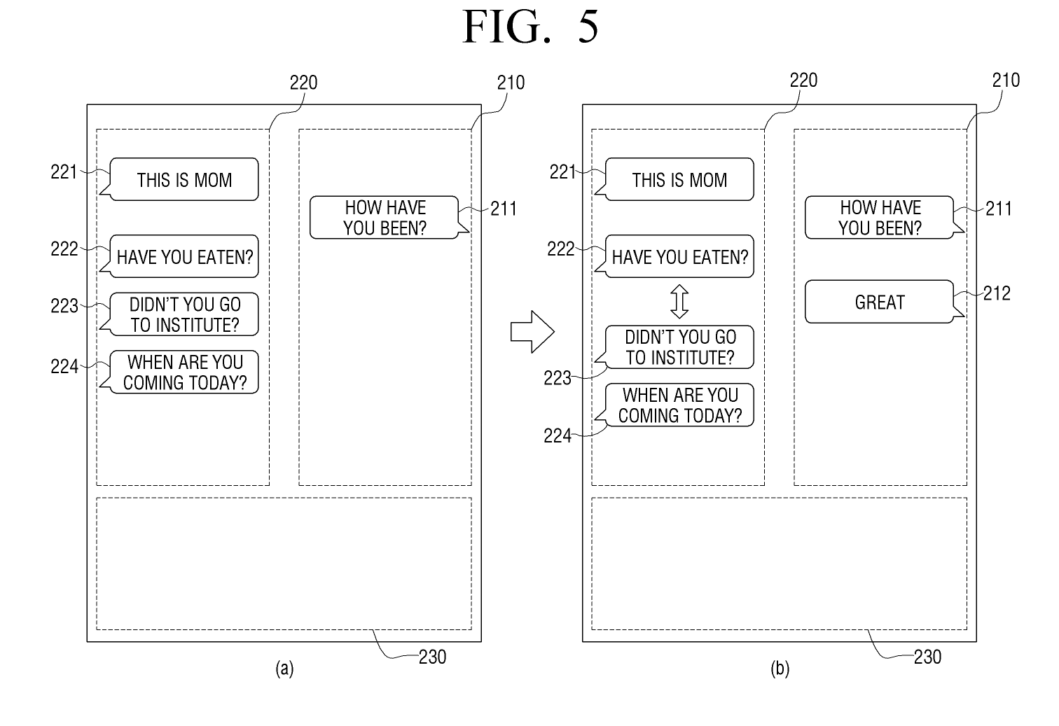

FIG. 5 is an exemplary view illustrating the feature that a terminal apparatus controls a message transmitted to another terminal apparatus based on message information received from another terminal apparatus according to an exemplary embodiment.

As illustrated in FIG. 5(a), the terminal apparatus may display the first message box 211 which displays a message received from another terminal apparatus in the first area 210, and display the second to the fifth message boxes 221˜224 which display each transmission messages transmitted to another terminal apparatus in the second area 220.

As such, the terminal apparatus may receive message information from another terminal apparatus while the first to the fifth message boxes 211, 221˜224 are displayed in the first and the second areas 210, 220. Herein, the message information may include a response message regarding one of transmission messages transmitted to another terminal apparatus and identification information (hereinafter, referred to as the first identification information) regarding the response message. In addition, the message information may further include identification information to display the response message around one of transmission messages transmitted to another terminal apparatus (hereinafter, referred to as the second identification information).

Accordingly, the terminal apparatus may select a message box including the second identification information which is included in the message information received from another terminal apparatus from among the second to the fifth message boxes 221˜224 displayed in the second area 220. For example, the identification information of “#2˜#5” may be set for the second to the fifth message boxes 221˜224 displayed in the second area 220 of the terminal apparatus. In addition, each message displayed on the second to the fifth message boxes 221˜224 may be transmitted to another terminal apparatus. In this case, another terminal apparatus may display each message received from the terminal apparatus in the form of message box, and identification information corresponding to the identification information of the second to the fifth message boxes 221˜224 may be set for the message box which displays each message.

For example, if the second identification information included in the message information received from another terminal apparatus is “#3”, the terminal apparatus may select a message box where identification information of “#3” is set with reference to the identification information set for the second to the fifth message boxes 221˜224. As illustrated in FIG. 5(b), if the message box where identification corresponding to the second identification information is set is the third message box 222, the terminal apparatus displays a response message included in the received message box around the third message box 222. That is, the terminal apparatus widens an interval or spacing (see double headed arrow) between the third message box 222 and the fourth message box 223 as much as a predetermined threshold value, and displays the sixth message box 212 where the response message received from another terminal apparatus is displayed in the first area 210 corresponding to the area where the above interval is secured. In this case, the terminal apparatus sets identification information regarding the sixth message box 212 using the first identification information received from another terminal apparatus. For example, if the first identification information received from another terminal apparatus is “#6”, the terminal apparatus may set “#6” as the identification information regarding the sixth message box 212. In addition, the terminal apparatus may display the color of the sixth message box 212 to be different from the colors of the first to the fifth message boxes 211, 221˜224. Accordingly, a user may find out that a response message regarding one of the second to the fifth message boxes 221˜224 is received.

Meanwhile, if the first identification information is not included in the message information received from another terminal apparatus, the terminal apparatus may display the sixth message box 212 after the message box which is generated for the last time based on information regarding time when each of the first to the fifth message boxes 211, 221˜224 displayed in the first and the second areas 210, 220 is generated. For example, if it is determined that the fifth message box 224 is generated for the last time from among the first to the fifth message boxes 211, 221˜224, the terminal apparatus may display the sixth message box 212 in the first area 210 which corresponds to an area displayed after the area where the fifth message box 224 is displayed.

Hereinafter, the operation that a terminal apparatus controls a message transmitted to another terminal apparatus from among a plurality of messages which are transmitted/received to/from another terminal apparatus according to a selection command on a displayed menu window according to an exemplary embodiment will be described.

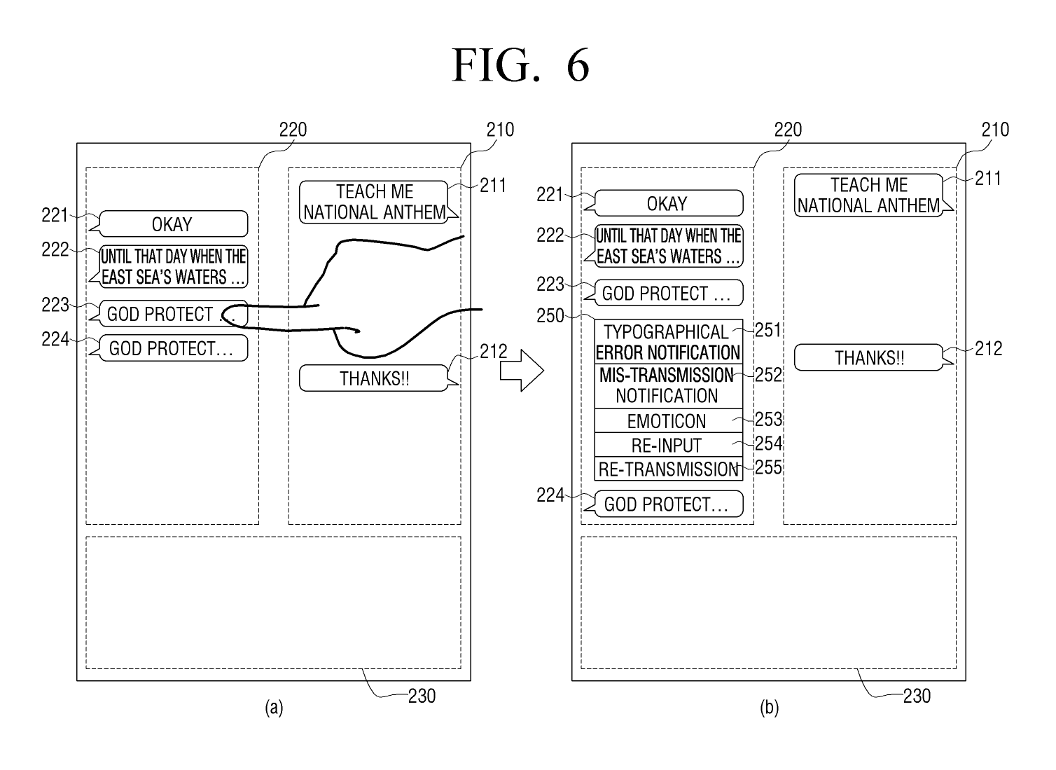

FIG. 6 is an exemplary view illustrating the feature that a terminal apparatus controls a message transmitted to another terminal apparatus according to a selection command on a displayed menu window according to an exemplary embodiment.

As illustrated in FIG. 6(a), the terminal apparatus may display the first and the second message boxes 211, 212 which display a message received from another terminal apparatus in the first area 210, and display the third to the sixth message boxes 221˜224 which display a message transmitted to another terminal apparatus in the second area 220.

For example, a message received from another terminal apparatus may be displayed on the first message box 211 in the first area 210. If a transmission command is input after a plurality of response messages regarding the message displayed on the first message box 211 are input while the first message box 211 is displayed, the terminal apparatus displays the third to the sixth message boxes 221˜224 which display each of the plurality of the input response messages in the second area 220. Subsequently, the terminal apparatus transmits the response messages displayed on each of the third to the sixth message boxes 221˜224 and identification information set for the third to the sixth message boxes 221˜224 to another terminal apparatus. Accordingly, when a plurality of response messages regarding a transmission message transmitted to the terminal apparatus are received, another terminal apparatus may generate and display a message box which displays each of the plurality of the received response messages.

Meanwhile, if a wrong response message is input on one of the third to the sixth message boxes 221˜224 displayed in the second area 220 of the terminal apparatus, a user may select the message box where the wrong response message is input. As illustrated in the drawing, if a wrong response message is input on the fifth message box 223 from among the third to the sixth message boxes 221˜224, a user may select the fifth message box 223 displayed in the second area 220.

When such a selection command is input, the terminal apparatus displays a menu window 250 to control the response message displayed on the fifth message box 223 around the fifth message box 223 as illustrated in FIG. 6(b). Herein, the menu window 250 may include an typographical error notification menu 251, a mis-transmission notification menu 252, an emoticon menu 253, a re-input menu 254, and a re-transmission menu 255. The menu window 250 may be displayed at the lower end of the fifth message box 223, or in the third area 230 such as a touch pad where the input unit 130 is displayed in the UI form. When one menu is selected while the menu window 250 is displayed, the terminal apparatus may control the response message displayed on the fifth message box 223 based on the selected menu.

Depending on an exemplary embodiment, when the typographical error notification menu 251 or the mis-transmission notification menu 252 is selected, the terminal apparatus displays a notification message notifying that there is a typographical error or mis-transmission, and transmits control information to display identification information regarding the fifth message box 223 and an notification message to another terminal apparatus. Accordingly, another terminal apparatus may change a message including identification information regarding the fifth message box 223 from among messages received from the terminal apparatus to a typographical error or mis-transmission notification message and display the same.

Meanwhile, when the emoticon menu 253 is selected from among menus included in the menu window 250, the terminal apparatus overlaps and displays a response message displayed on the fifth message box 223 with an emoticon, and transmits control information to display identification information regarding the fifth message box 223 and an emoticon to another terminal apparatus. Accordingly, another terminal apparatus may overlap and display a message including the identification information regarding the fifth message box 223 from among messages received from the terminal apparatus with an emoticon.

Meanwhile, when the re-input menu 253 is selected from among menus included in the menu window 250, the terminal apparatus deletes the fifth message box 223, and displays the input window 240 where the fifth message box 223 is deleted. Subsequently, when a new response message is input and then, a transmission command is input through the input window 240, the terminal apparatus generates and displays the fifth message box 223 which displays the newly-input response message. The terminal apparatus transmits control information to display the identification information regarding the fifth message box 223 and the new response message displayed on the fifth message box 223 to another terminal apparatus. Accordingly, another terminal apparatus may change and display a message including the identification information regarding the fifth message box 223 from among messages received from the terminal apparatus to a new response message received from the terminal apparatus.

Meanwhile, when the re-transmission menu 254 is selected from among menus included in the menu window 250, the terminal apparatus transmits control information to display a message displayed on the fifth message box 223 to another terminal apparatus. Accordingly, another terminal apparatus may display the corresponding message right after the message which is transmitted or received right before the message displayed on the fifth message box 223 is received from the terminal apparatus. That is, another terminal apparatus may overlap and display the message displayed on the fifth message box 223 with the corresponding received message.

So far, the operation of controlling messages that a terminal apparatus transmits/receives to/from another terminal apparatus according to an exemplary embodiment has been described. Hereinafter, the method that a terminal apparatus controls messages transmitted/receives to/from another terminal apparatus according to an exemplary embodiment will be described.

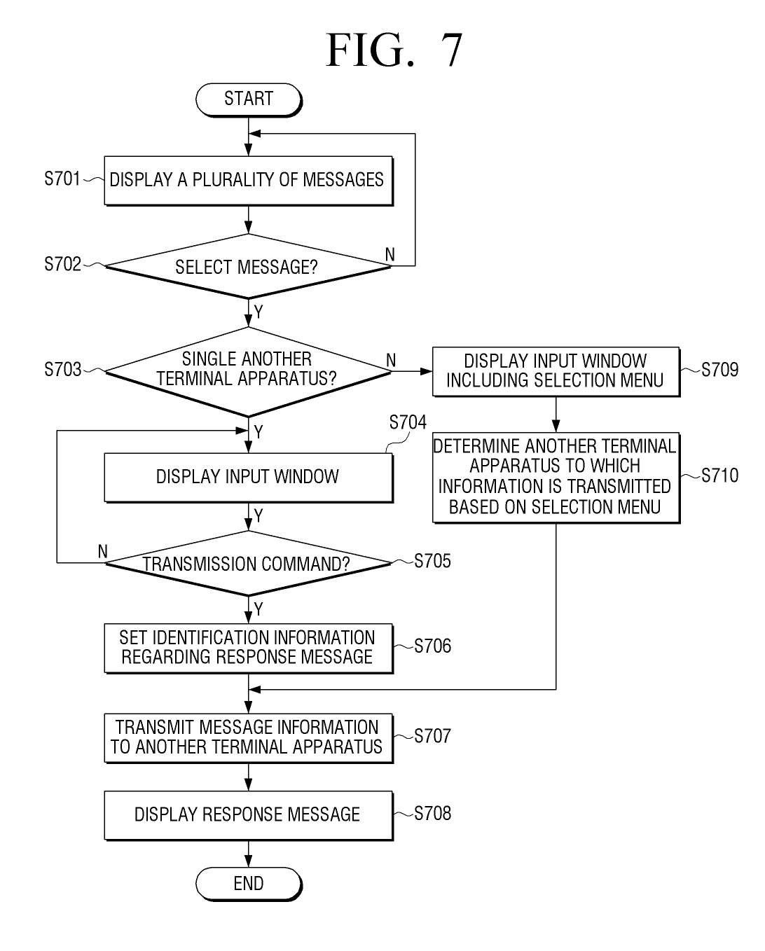

FIG. 7 is a flowchart illustrating a method for controlling a message that a terminal apparatus receives from another terminal apparatus according to an exemplary embodiment.

As illustrated in FIG. 7, a terminal apparatus displays a plurality of messages that the terminal apparatus transmits/receives to/from another terminal apparatus (S701). Specifically, the terminal apparatus may display a plurality of messages which are received from another terminal apparatus in the first area 210, and display a plurality of messages which are transmitted to another terminal apparatus in the second area 220. Identification information may be set for each of the plurality of messages displayed in the first and the second areas 210, 220.

Meanwhile, when one message displayed in the first area 210 is selected from among a plurality of messages displayed in the first and the second areas 210, 220, the terminal apparatus determines whether the plurality of messages displayed in the first area 210 are received from a single another terminal apparatus (S702, S703). If it is determined that the plurality of messages displayed in the first area 210 are received from a single another terminal apparatus, the terminal apparatus displays an input window to generate a response message regarding the selected message (S704). Herein, the input window to generate the response message may be displayed around the selected message.

Subsequently, when a transmission command is input after the response message is input through the input window, the terminal apparatus sets identification information regarding the response message input through the input window (S705, S706). The terminal apparatus transmits message information including identification information of the selected message, the response message, and identification information regarding the response message to another terminal apparatus (S707). Subsequently, the terminal apparatus displays the response message input through the input window around the selected message according to a user command (S708).

However, the present invention is not limited thereto, and when a transmission command is input after the response message is input through the input window, the terminal apparatus may display the response message input through the input window and then, transmit message information including identification information of the selected message, the response message, and identification information of the response message to another terminal apparatus according to a user command. Meanwhile, the terminal apparatus according to an exemplary embodiment may display the color of the response message displayed around the selected message according to a user command to be different from the colors of a plurality of other displayed messages.

Meanwhile, if it is determined that the plurality of messages displayed in the first area 210 in step S703 are received from a plurality of other terminal apparatuses, the terminal apparatus displays an input window including a selection menu to select another terminal apparatus to which the response message is transmitted (S709). Subsequently, when the selection menu included in the input window is selected, the terminal apparatus determines another terminal apparatus to which message information is transmitted based on the selected selection menu (S710). When at least one another terminal apparatus to which the message information is transmitted is determined based on the selection menu, the terminal apparatus may transmit the message information to the predetermined at least one another terminal apparatus through step S707.

Hereinafter, a method that a terminal apparatus controls a transmission message transmitted to another terminal apparatus based on message information received from another terminal apparatus according to an exemplary embodiment will be described.

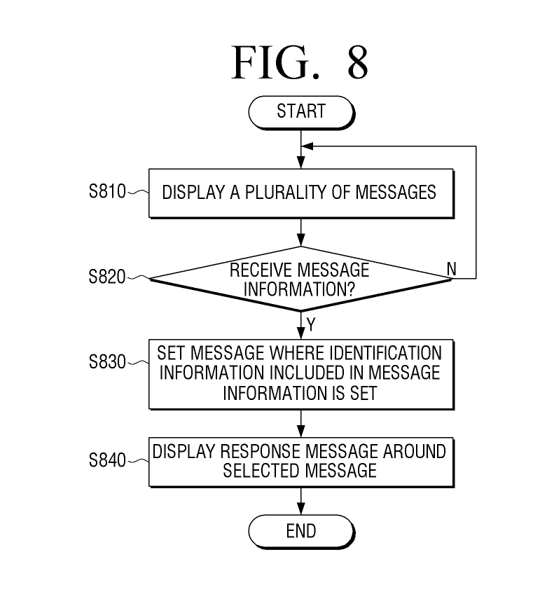

FIG. 8 is a flowchart illustrating a method that a terminal apparatus controls a message transmitted to another terminal apparatus based on message information received from another terminal apparatus according to an exemplary embodiment.

As illustrated in FIG. 8, a terminal apparatus displays a plurality of messages which are transmitted/received to/from another terminal apparatus (S810). As described above, the terminal apparatus may display a message received from another terminal apparatus in the first area 210, and display a message transmitted to another terminal apparatus in the second area 220.

Subsequently, when message information including identification information regarding one of a plurality of messages which are transmitted to another terminal apparatus and a response message is received, the terminal apparatus selects a message where the received identification information is set from among the messages which are transmitted to another terminal apparatus (S820, S830).

Specifically, the terminal apparatus may transmit a plurality of messages displayed in the second area 220 and identification information regarding each message to another terminal apparatus. Accordingly, another terminal apparatus may display each message received from the terminal apparatus on the screen and set identification information for each message. Subsequently, when one of a plurality of messages received from the terminal apparatus is selected and a transmission message of a response message regarding the selected message is input, another terminal apparatus may transmit message information including identification information set for the selected message and a response message to the terminal apparatus. Accordingly, the terminal apparatus may compare the identification information which is set for each of the plurality of messages displayed in the second area 220 with the identification information included in the message information received from another terminal apparatus and selects a message where the same identification information is set.

When a message where the identification information received from another terminal apparatus is set is selected, the terminal apparatus displays a response message included in the message information received from another terminal apparatus around the selected message (S840). Meanwhile, the message information received from another terminal apparatus may further include identification information regarding the response message. Accordingly, the terminal apparatus may set identification information regarding the response message displayed around the selected message.

Hereinafter, the method of controlling that a terminal apparatus controls a message transmitted to another terminal apparatus according to an exemplary embodiment will be described.

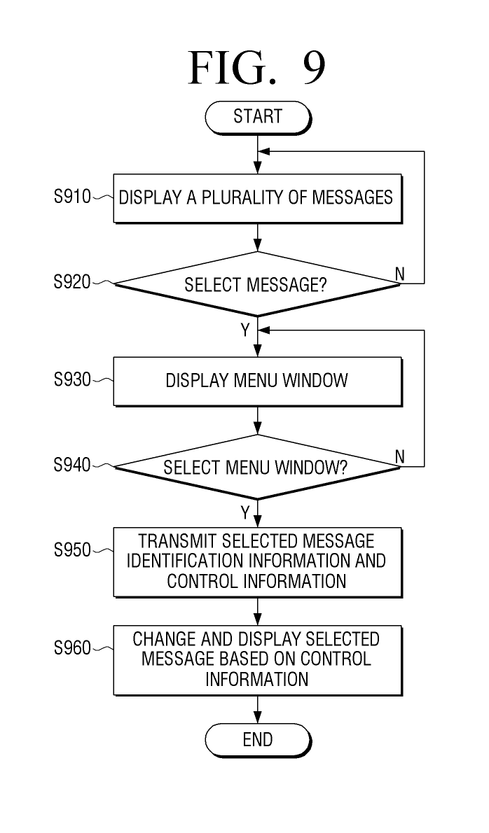

FIG. 9 is a flowchart illustrating a method that a terminal apparatus controls a message transmitted to another terminal apparatus according to an exemplary embodiment.

As illustrated in FIG. 9, the terminal apparatus displays a plurality of messages which are transmitted/received to/from another terminal apparatus (S910). As described above, the terminal apparatus may display a message received from another terminal apparatus in the first area 210, and display a message transmitted to another terminal apparatus in the second area 220.

When one message displayed in the second area 220 is selected from among a plurality of messages displayed in the first and the second areas 210, 220, the terminal apparatus displays a menu window to control the selected message (S920, S930). Herein, the menu window may include at least one of a typographical error notification menu, a mis-transmission notification menu, an emoticon input menu, a re-input menu, and a re-transmission menu. When a user command to control the selected menu is input through the corresponding menu window, the terminal apparatus transmits identification information regarding the selected message and control information corresponding to the input user command to another terminal apparatus (S940, S950). Subsequently, the terminal apparatus changes and displays the selected message based on the control information corresponding to the input user command (S960). However, the present invention is not limited thereto, and when a user command to control the selected message is input through the menu window, the terminal apparatus may change and display the selected message based on the control information corresponding to the input user command and then, may transmit the identification information regarding the selected message and the control information to another terminal apparatus.

Specifically, when one of a plurality of messages displayed in the second area 220 is selected, the terminal apparatus displays a menu window around the selected message. As described above, the menu window may include at least one of a typographical error notification menu, a mis-transmission notification menu, an emoticon input menu, a re-input menu, and a re-transmission menu. Accordingly, when one of a plurality of menus included in the menu window is selected, the terminal apparatus transmits control information to change the selected message and identification information regarding the selected message based on the selected menu. Subsequently, the terminal apparatus changes and displays the selected message based on the selected menu.

Depending on exemplary embodiment, when a typographical error notification menu or a mis-transmission menu is selected from among menus included in the menu window, the terminal apparatus changes the selected message to a notification message notifying that a typographical error or mis-transmission has occurred and displays the message. In addition, the terminal apparatus transmits identification information regarding the selected message or a notification message notifying that a typographical error or mis-transmission has occurred to another terminal apparatus. Accordingly, another terminal apparatus may change the message including the identification information received from the terminal apparatus into a notification message regarding a typographical error or mis-transmission and display the message.

When an emoticon menu is selected from among menus included in the menu window, the terminal apparatus overlaps and displays the selected message with an emoticon. In addition, the terminal apparatus transmits identification information regarding the selected message and control message to display an emoticon to another terminal apparatus. Accordingly, another terminal apparatus may overlap and display the message including the identification information received from the terminal apparatus with an emoticon.

When a re-input menu is selected from among menus included in the menu window, the terminal apparatus deletes the selected message, and displays an input window where the deleted message is displayed. Subsequently, when a transmission message is input after a new response message is input through the input window, the terminal apparatus displays the newly-input response message in the area where the selected message is deleted. Subsequently, the terminal apparatus transmits identification information regarding the selected message and control information to change and display the selected message into a new response message to another terminal apparatus. Accordingly, the terminal apparatus may change the message including the identification information received from the terminal apparatus to a new response message and display the message.

When a re-transmission menu is selected from among menus included in the menu window, the terminal apparatus re-transmits the selected message. Accordingly, another terminal apparatus may display the message received from the terminal apparatus.

The foregoing embodiments and advantages are merely exemplary and are not to be construed as limiting the present invention. The present teaching can be readily applied to other types of apparatuses. Also, the description of the exemplary embodiments of the present inventive concept is intended to be illustrative, and not to limit the scope of the claims, and many alternatives, modifications, and variations will be apparent to those skilled in the art.

The embodiments of the terminal apparatus or terminal, method can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on non-transitory computer-readable media comprising computer-readable recording media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Further, according to an aspect of the embodiments, any combinations of the described features, functions and/or operations can be provided.

What is claimed is:

1. A method for controlling a terminal apparatus, comprising:
displaying a plurality of messages which are one of transmitted to and received from another terminal apparatus;
displaying, when one of a plurality of the displayed messages is selected, an input window to generate a response message for the selected one of the plurality of displayed messages;
transmitting, when a transmission command is input after a response message is input into the input window, identification information of the selected one of the plurality of displayed messages and the response message to the another terminal apparatus; and
displaying the response message around the selected one of the plurality of displayed messages.

2. The method as claimed in claim 1, wherein the input window to enter the response message is displayed around the selected one of the plurality of displayed messages.

3. The method as claimed in claim 1, wherein the transmitting comprises transmitting identification information of the response message to the another terminal apparatus.

4. The method as claimed in claim 1, wherein the displaying the response message comprises displaying the response message in a color which is different from colors of the plurality of the displayed messages.

5. The method as claimed in claim 1, further comprising:
displaying, when identification information regarding one of a plurality of messages which are transmitted to the another terminal apparatus and a response message are received from the another terminal apparatus, the received response message around a transmission message corresponding to the identification information.

6. The method as claimed in claim 1, further comprising:
displaying, when a transmission message which is transmitted to the another terminal apparatus is selected from among the plurality of the displayed messages, a menu window to control the selected transmission message; and
transmitting, when a user command to control the selected transmission message is input through the menu window, identification information regarding the selected transmission message and control information corresponding to the user command to the another terminal apparatus.

7. The method as claimed in claim 6, wherein the menu window includes at least one of a typographical error notification menu, a mis-transmission notification menu, an emoticon input menu, a re-input menu, and a re-transmission menu.

8. The method as claimed in claim 6, further comprising:
changing and displaying the selected transmission message according to the control information.

9. The method as claimed in claim 1, wherein when messages are one of transmitted to and received from a plurality of other terminal apparatuses, the input window includes a selection menu to select another terminal apparatus to which the response message is transmitted, and wherein the transmitting comprises transmitting identification information of the selected message and the response message to at least one another terminal apparatus which is selected through the selection menu.

10. A terminal apparatus, comprising:
a communicator configured to perform communication with another terminal apparatus;
a display configured to display messages which are one of transmitted to and received from the another terminal apparatus through the communicator;
an input unit configured to receive a user command; and
a controller configured to the communicator and the display to display, when one of a plurality of the displayed messages is selected according to a user command input through the input unit, an input window to generate a response message of the selected message, and to transmit, when a transmission command is input after a response message is input on the input window through the input unit, identification information of the selected message and the response message to the another terminal apparatus and display the response message around the selected message.

11. The apparatus as claimed in claim 10, wherein the display displays an input window to generate the response message around the selected message.

12. The apparatus as claimed in claim 10, wherein the controller controls the communicator to transmit identification information of the response message to the another terminal apparatus.

13. The apparatus as claimed in claim 10, wherein the controller controls the display to display the response message in a color which is different from colors of a plurality of the display messages.

14. The apparatus as claimed in claim 10, wherein the controller controls the display to display, when identification information regarding one of a plurality of messages which are transmitted to the another terminal apparatus and a response message are received from the another terminal apparatus through the communicator, the received response message around a transmission message corresponding to the identification information.

15. The apparatus as claimed in claim 10, wherein the controller controls the display to display, when a transmission message transmitted to the another terminal apparatus is selected from among a plurality of the displayed messages, a menu window to control the selected transmission message, and wherein the controller controls the communicator to transmit, when a user command to control the selected transmission message is input through the menu window, identification information regarding the selected transmission message and control information corresponding to the user command to the another terminal apparatus.

16. The apparatus as claimed in claim 15, wherein the menu window includes at least one of a typographical error notification menu, a mis-transmission notification menu, an emoticon input menu, a re-input menu, and a re-transmission menu.

17. The apparatus as claimed in claim 15, wherein the controller controls the display to change and display the selected transmission message according to the control information.

18. The apparatus as claimed in claim 10, wherein when messages are one of transmitted to and received from a plurality of other terminal apparatuses, the input window includes a selection menu to another terminal apparatus to which the response message is transmitted, and wherein the controller controls the communicator to transmit identification information of the selected message and the response message to at least one another terminal apparatus which is selected through the selection menu.

19. A method for controlling a first terminal apparatus, comprising:
displaying messages transmitted to and received from a second terminal apparatus;
allowing one of the messages to be selected as a selected message;
displaying an input window for a response to the selected message;
allowing a response message to be input;
transmitting a selected message identification of the selected message and the response message to the second terminal when a transmission command is input; and
displaying the response message in direct association the selected message.
